(19) United States
(12) Patent Application Publication
(10) Pub. No.: US 2021/0286289 A1
(43) Pub. Date: Sep. 16, 2021

(54) IMAGE FORMING APPARATUS

(71) Applicant: KYOCERA Document Solutions Inc., Osaka-shi (JP)

(72) Inventor: Masaki SATO, Osaka-shi (JP)

(21) Appl. No.: 17/194,425

(22) Filed: Mar. 8, 2021

(30) Foreign Application Priority Data
Mar. 11, 2020 (JP) 2020-041904

(51) Int. Cl. G03G 15/08; G03G 21/10

(52) U.S. Cl. CPC G03G 15/0856; G03G 21/10

(57) ABSTRACT

An image forming apparatus including: a printing unit; a bottle which is rotationally driven in a predetermined rotation direction, whereby the waste developer conveyed from the printing unit to the opening is accommodated inside and the waste developer inside is conveyed to a second end side in the longitudinal direction; and a capacitive sensor having a first detection electrode and a first ground electrode arranged in parallel, where a first detection surface of an electrostatic capacitance formed by the first detection electrode and the first ground electrode is arranged to directly face a portion of an outer peripheral surface of the bottle which is positioned obliquely upward with respect to a center line of rotation of the bottle in a region which moves from a bottom to a top when the bottle rotates in the predetermined rotation direction.

### INCORPORATION BY REFERENCE

This application claims priority to Japanese Patent Application No. 2020-041904, filed Mar. 11, 2020, and incorporates the contents thereof.

The present disclosure relates to an image forming apparatus including a rotary bottle for containing waste developer.

### BACKGROUND

Generally, an electrophotographic image forming apparatus includes a rotary bottle for containing a powdered waste developer collected from a printing apparatus for forming an image on a sheet. The bottle is a container having an opening formed at one end in a longitudinal direction. The bottle may be referred to as a waste toner bottle, for example.

The bottle has a helical convex portion which projects spirally along the longitudinal direction on an inner peripheral surface thereof. The bottle is disposed in a state in which the longitudinal direction is sideways and is rotationally driven. The rotating bottle accommodates the waste developer conveyed to the opening, and conveys the waste developer to the back of the bottle.

The image forming apparatus further includes a developer sensor for detecting an amount of the waste developer in the bottle. When the developer sensor detects that the amount of the waste developer in the bottle has reached the upper limit, the printing process by the printing apparatus is prohibited.

For example, it is known that the image forming apparatus includes a capacitive sensor for detecting the amount of the waste developer in the bottle, and the capacitive sensor includes two electrodes arranged to face each other via the bottle.

In some cases, the capacitive sensor has two electrodes arranged in parallel. Hereinafter, such capacitive sensor will be referred to as a parallel capacitive sensor. The two electrodes include a detection electrode and a ground electrode.

A cable connected to the parallel electrostatic capacitive sensor does not need to be wired across the bottle. Therefore, when the parallel capacitive sensor is employed, wiring is simplified.

On the other hand, when the bottle is rotating, the waste developer in the bottle repeatedly moves according to the movement of the inner peripheral surface of the bottle and then falls off. As a result, the upper surface of the waste developer in the bottle is maintained to be generally inclined at the repose angle of the waste developer.

Therefore, the waste developer is unevenly deposited on one side of the bottle. More specifically, the waste developer is unevenly deposited on one of the side surfaces of the bottle, which moves from the bottom to the top when the bottle rotates.

When the parallel capacitive sensor is arranged to face a portion of the bottle where the waste developer is concentrated, the capacitance detected by the parallel capacitive sensor may reach a measurement upper limit even though a sufficient amount of empty space remains in the bottle.

That is, there is a possibility that the parallel capacitive sensor cannot detect a change in the amount of the waste developer in the bottle even though the empty space in the bottle is large.

### SUMMARY

An image forming apparatus according to one aspect of the present disclosure includes: a printing unit for performing a printing process for forming a toner image on a sheet and discharging a powdered waste developer; a bottle which is a container having an opening formed at a first end in a longitudinal direction, is disposed in a state in which the longitudinal direction is sideways, and is rotationally driven in a predetermined rotation direction, whereby the waste developer conveyed from the printing unit to the opening is accommodated inside and the waste developer inside is conveyed to a second end side in the longitudinal direction; and a capacitive sensor having a first detection electrode and a first ground electrode arranged in parallel, where a detection surface of an electrostatic capacitance formed by the first detection electrode and the first ground electrode is arranged to directly face a portion of an outer peripheral surface of the bottle which is positioned obliquely upward with respect to a center line of rotation of the bottle in a region which moves from a bottom to a top when the bottle rotates in the predetermined rotation direction.

An image forming apparatus according to another aspect of the present disclosure includes the printing apparatus, the bottle, and a capacitive sensor. The capacitive sensor has a first detection electrode and a first ground electrode arranged in parallel, where a detection surface of an electrostatic capacitance formed by the first detection electrode and the first ground electrode is arranged to directly face a portion of an outer peripheral surface of the bottle which is positioned at the same height as or obliquely upward with respect to a center line of rotation of the bottle in a region which moves from a top to a bottom when the bottle rotates in the predetermined rotation direction.

The objects, features, and advantages of the present disclosure will become more apparent from the following detailed description. Reference the detailed description, reference is made to the accompanying drawings in which preferred embodiments of the present disclosure are shown as examples.

### BRIEF DESCRIPTION OF THE DRAWINGS

FIG. 1 is a block diagram of an image forming apparatus according to a first embodiment of the present invention.

FIG. 2 is a block diagram showing a bottle and its peripheral portion in the image forming apparatus according to the first embodiment.

FIG. 3 is a block diagram showing a configuration of control-related equipment in the image forming apparatus according to the first embodiment.

FIG. 4 is a view showing an arrangement position of a capacitive sensor in the image forming apparatus according to the first embodiment.

FIG. 5 is the block diagram of a bottle and its peripheral portion in the image forming apparatus according to a second embodiment.

FIG. 6 is a view showing the arrangement positions of two capacitive sensors in the image forming apparatus according to the second embodiment.

FIG. 7 is a view showing an arrangement position of the capacitive sensor in the image forming apparatus according to the third embodiment.

### DETAILED DESCRIPTION

Embodiments of the present disclosure will now be described with reference to the drawings. It should be noted that the following embodiment is an embodiment of the present disclosure and does not limit the technical scope of the present disclosure.

### First Embodiment: Configuration of Image Forming Apparatus 10

An image forming apparatus 10 according to the first embodiment is an apparatus for forming an image on a sheet by an electrophotographic method. The sheet is a sheet-like image forming medium such as paper or a resin film.

The image forming apparatus 10 includes a sheet feeding unit 30, a sheet conveying unit 3, a printing unit 4, one or more toner containers 400, a bottle 5, and a waste developer collecting unit 6 disposed in a main body 1.

The sheet feeding unit 30 accommodates a plurality of sheets and feeds the accommodated sheets one by one to a sheet conveying path 300. The sheet conveying unit 3 conveys a sheet along the sheet conveying path 300.

The printing unit 4 executes printing processing for forming a toner image on the sheet supplied from the sheet feeding unit 30 through the sheet conveying unit 3 in an electrophotographic method.

The printing unit 4 includes a laser scanning unit 40, one or more image forming unit 4x, a transfer unit 44, and a fixing unit 46.

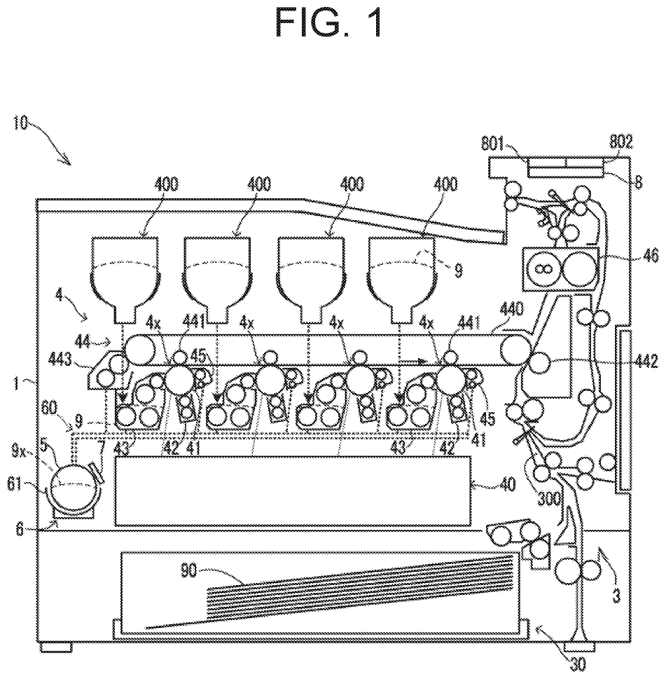

In the example shown in FIG. 1, the printing unit 4 is a tandem color image printing device. Therefore, the printing unit 4 includes four toner containers 400 and four image forming units 4x corresponding to four colors of toner. Each of the image forming units 4x includes a drum-shaped photosensitive member 41, a charging unit 42, a developing unit 43, and a drum cleaning unit 45.

In each of the image forming units 4x, the photosensitive member 41 rotates, and the charging unit 42 charges the outer peripheral surface of the photosensitive member 41. Further, in each of the image forming units 4x, the developing unit 43 develops the electrostatic latent image formed on the outer peripheral surface of the photosensitive member 41 by the laser scanning unit 40 into a toner image. The photosensitive member 41 is an example of an image carrier.

Further, the transfer unit 44 includes an intermediate transfer belt 440, four primary transfer units 441, a secondary transfer unit 442, and a belt cleaning unit 443.

The intermediate transfer belt 440 rotates while being in contact with the four photosensitive members 41, and the four primary transfer units 441 transfer the toner images from the four photosensitive members 41 to the intermediate transfer belt 440.

The secondary transfer unit 442 transfers the toner image on the intermediate transfer belt 440 onto the sheet being conveyed along the sheet conveying path 300. The belt cleaning unit 443 removes waste toner from the intermediate transfer belt 440. In each of the image forming units 4x, the drum cleaning unit 45 removes the waste toner remaining on the outer peripheral surface of the photosensitive member 41.

The fixing unit 46 fixes the toner image on the sheet by applying pressure while heating the toner image on the sheet. The sheet conveying unit 3 discharges the sheet on which the image has been formed from the sheet conveying path 300.

Each toner container 400 supplies toner 9 to a corresponding developing unit 43 in the printing unit 4.

In the printing unit 4, a developing unit 43 discharges a powdered waste developer 9x containing waste toner that has been retained for a long time. Further, the drum cleaning unit 45 and the belt cleaning unit 443 discharge the waste developer 9x as the removed material. The waste developer collecting unit 6 collects the waste developer 9x discharged from the printing unit 4 into the bottle 5.

Further, when the developing unit 43 performs development using a two-component developer containing a toner 9 and a carrier, the waste developer also contains a waste carrier which has stayed in the developing unit 43 for a long time. In some cases, the waste developer may contain the removed material by the drum cleaning unit 45 and the belt cleaning unit 443 and the waste carrier.

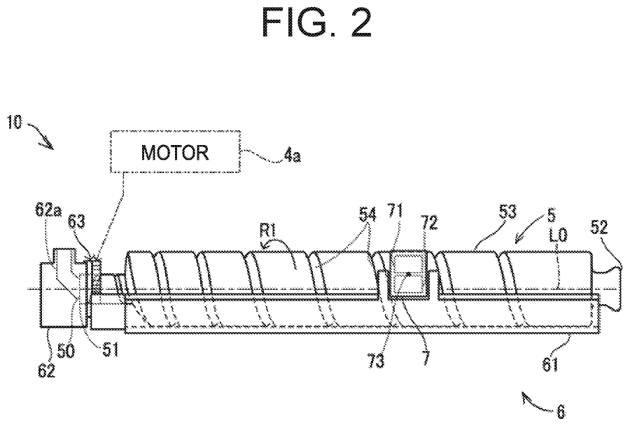

As shown in FIG. 2, the bottle 5 is a container having an opening 50 formed at a first end 51 in a longitudinal direction. For example, the bottle 5 is a container made of synthetic resin. The bottle 5 has a cylindrical outer peripheral surface 53.

The bottle 5 has a helical convex portion 54 projecting spirally along the longitudinal direction on the inner surface thereof. The helical convex portion 54 is a helical concave portion when viewed from the outside of the bottle 5.

The bottle 5 is disposed in a state in which the longitudinal direction is sideways and is rotationally driven. Thus, the bottle 5 accommodates the waste developer 9x conveyed from the developing unit 43 and the belt cleaning unit 443 to the opening 50, and conveys the waste developer 9x to a second end 52 side in the longitudinal direction. The center line of the outer peripheral surface 53 of the bottle 5 is the rotation center line L0 of the bottle 5.

The image forming apparatus 10 further includes a controller 8, an operation unit 801, and a display device 802. The operation unit 801 is a touch panel or an operation button for receiving a human operation. The display device 802 is a liquid crystal panel unit for displaying information.

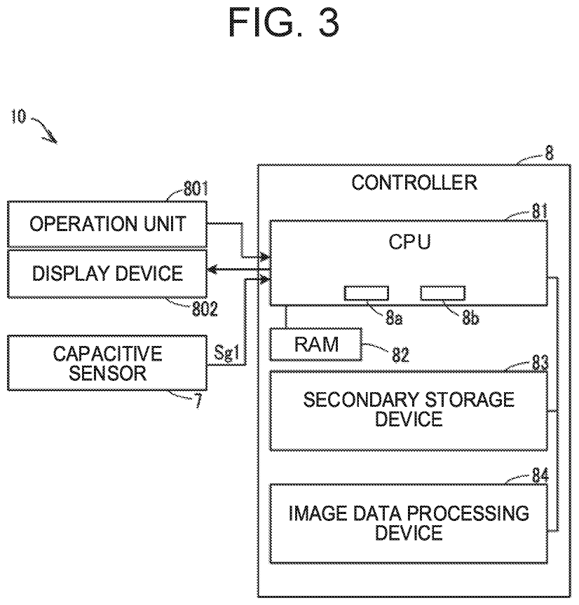

As shown in FIG. 3, the controller 8 includes a central processing unit (CPU) 81, a random access memory (RAM) 82, a secondary storage device 83, an image data processing device 84, and the like.

The CPU 81 is an example of a processor that executes a program stored in the secondary storage device 83 or the like, to control electrical equipment in the image forming apparatus 10 and perform various kinds of data processing.

It is also conceivable that another processor such as a digital signal processor (DSP) executes various kinds of control and data processing in place of the CPU 81.

The RAM 82 is a storage device for primarily storing the program to be executed by the CPU 81 and data to be output and referenced in the process of executing the program by the CPU 81.

The secondary storage device 83 is a computer-readable nonvolatile data storage device. The secondary storage device 83 can store the program and various kinds of data. For example, one of or a combination of a hard disk drive and an SSD (Solid State Drive) is employed as the secondary storage device 83.

The image data processing device 84 executes image processing such as processing or conversion processing on the image data used in the printing processing. For example, the image data processing device 84 executes processing for converting print job data into raster data for printing.

For example, the image data processing device 84 may be implemented by one or both of a processor, such as a DSP, and an integrated circuit, such as an application specific integrated circuit (ASIC).

### <Waste Developer Collecting Unit 6>

As shown in FIGS. 1 and 2, the waste developer collecting unit 6 includes a waste developer conveying mechanism 60, a bottle mounting portion 61, a carry-in relay portion 62, and a bottle driving mechanism 63.

The bottle mounting portion 61 supports a bottle 5 to accommodate the waste developer 9x. The bottle 5 is disposed on the bottle mounting portion 61 in a state in which the longitudinal direction is sideways. The waste developer conveying mechanism 60 conveys the waste developer 9x discharged from the developing unit 43 and the belt cleaning unit 443 to the carry-in relay portion 62.

The carry-in relay portion 62 is a member forming a guide duct 62a. The carry-in relay portion 62 guides the waste developer 9x conveyed into the guide duct 62a by the waste developer conveying mechanism 60 to the opening 50 of the bottle 5 supported by the bottle mounting portion 61.

The bottle driving mechanism 63 is connected to the first end 51 of the bottle 5 supported by the bottle mounting portion 61, and rotationally drives the bottle 5. A motor 4a for rotationally driving the photosensitive member 41 of the printing unit 4 also serves as a driving source for the waste developer conveying mechanism 60 and the bottle driving mechanism 63 (see FIG. 2).

The motor 4a is controlled by the controller 8 (see FIG. 2). In the present embodiment, the motor 4a and the bottle driving mechanism 63 are examples of driving devices for rotating the bottle 5.

The bottle driving mechanism 63 transmits the rotational force of the motor 4a to the first end 51 of the bottle 5. The bottle 5 receives power from the bottle driving mechanism 63 and rotates in a predetermined rotation direction R1.

By rotating the bottle 5 in the predetermined rotation direction R1, the waste developer 9x in the bottle 5 is leveled along the longitudinal direction of the bottle 5 while being transported to the second end 52 side. The rotation of the bottle 5 prevents the waste developer 9x from staying toward the opening 50 in the bottle 5.

The bottle 5 is removably mounted to the bottle mounting portion 61 and the bottle driving mechanism 63. When the amount of the waste developer 9x in the bottle 5 reaches the upper limit, the bottle 5 is replaced.

As shown in FIGS. 1 to 3, the image forming apparatus 10 further includes a capacitive sensor 7 disposed opposite to the outer peripheral surface 53 of the bottle 5. The capacitive sensor 7 detects the capacitance of the region in front of the capacitive sensor 7.

The capacitance detected by the capacitive sensor 7 increases with an increase in the amount of the waste developer 9x in the bottle 5. Therefore, the capacitance detected by the capacitive sensor 7 represents the amount of the waste developer 9x in the bottle 5.

In some cases, the capacitive sensor 7 has two electrodes arranged in parallel. Hereinafter, such a capacitive sensor will be referred to as a parallel capacitive sensor. The capacitive sensor 7 of the image forming apparatus 10 is the parallel capacitive sensor. Two electrodes of the capacitive sensor 7 include a detection electrode 71 and a ground electrode 72.

A cable connected to the parallel capacitive sensor 7 does not need to be wired across both sides of the bottle 5. Therefore, when the parallel capacitive sensor 7 is employed, the wiring is simplified.

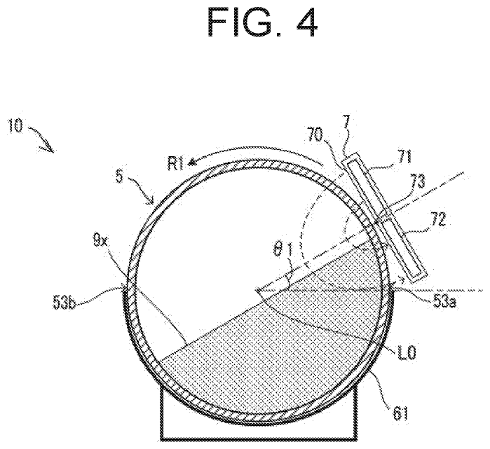

On the other hand, when the bottle 5 is rotating, the waste developer 9x in the bottle 5 repeatedly moves according to the movement of the inner peripheral surface of the bottle 5 and then collapses. As a result, the upper surface of the waste developer 9x in the bottle 5 is maintained to be generally inclined at a repose angle of the waste developer 9x (see FIG. 4).

Therefore, the waste developer 9x is unevenly deposited on one side of the bottle 5. Specifically, the waste developer 9x is unevenly deposited on one of the side surfaces of the bottle 5, which moves from the bottom to the top when the bottle 5 rotates in the predetermined rotation direction R1 (see FIG. 4).

When the capacitive sensor 7 is disposed to face the portion of the bottle 5 where the waste developer 9x is concentrated, there is a possibility that the electrostatic capacitance detected by the capacitive sensor 7 reaches the measurement upper limit even though a sufficient amount of empty space remains in the bottle 5.

That is, there is a possibility that the capacitive sensor 7 cannot detect a change in the amount of the waste developer 9x in the bottle 5 even though the empty space in the bottle 5 is large.

On the other hand, the image forming apparatus 10 has a configuration which can prevent a case in which the capacitive sensor 7 cannot detect the change in the amount of the waste developer 9x in the bottle 5 even though the empty space in the bottle 5 is large. The configuration will be described below.

The capacitive sensor 7 has an electrostatic capacitance detecting surface 70 formed by a detection electrode 71 and a ground electrode 72 arranged in parallel. The capacitive sensor 7 is an example of a first capacitive sensor. The detection electrode 71 and the ground electrode 72 are examples of the first detection electrode and the first ground electrode, respectively.

The capacitive sensor 7 is disposed closer to the second end 52 than the first end 51 in the longitudinal direction of the bottle 5 (see FIG. 2).

In the following description, a region of the outer peripheral surface 53 of the bottle 5 which moves from the bottom to the top when the bottle 5 rotates in the predetermined rotation direction R1 is referred to as a first outer peripheral region 53a (see FIG. 4). A region of the outer peripheral surface 53 of the bottle 5 which moves from the top to the bottom when the bottle 5 rotates in the predetermined rotation direction R1 is referred to as a second outer peripheral region 53b (see FIG. 4).

As shown in FIG. 4, the capacitive sensor 7 is disposed in a state in which the detection surface 70 of the capacitive sensor 7 directly faces a portion of the first outer peripheral region 53a of the bottle 5 that is positioned obliquely above the rotation center line L0 of the bottle 5.

In the present embodiment, the capacitive sensor 7 is arranged such that the detection electrode 71 and the ground electrode 72 are arranged in a vertical direction and the detection surface 70 is directed obliquely downward. In this case, the capacitive sensor 7 is arranged in such a state that an intermediate portion 73 between the detection electrode 71 and the ground electrode 72 on the detection surface 70 faces obliquely upward with respect to the rotation center line L0 of the bottle 5 in the first outer peripheral region 53a of the bottle 5.

Generally, the repose angle of the waste developer 9x is about 30 degrees. For this reason, it is preferable that the capacitive sensor 7 is arranged such that the elevation angle θ1 of viewing the intermediate portion 73 between the detection electrode 71 and the ground electrode 72 on the detection surface 70 from the rotation center line L0 is 15 to 30 degrees.

By arranging the capacitive sensor 7 as described above, it is possible to detect a change in which the waste developer 9x is unevenly deposited on the first outer peripheral region 53a side in the bottle 5 until the empty space in the bottle 5 becomes small.

### <Processing of the CPU 81>

The CPU 81 of the controller 8 includes a state determination unit 8a and a device control unit 8b which are realized by executing a computer program stored in the secondary storage device 83 (see FIG. 3). The state determination unit 8a determines the state of the image forming apparatus 10 and notifies the determination result.

The device control unit 8b controls various devices including the printing unit 4 in the image forming apparatus 10. For example, the device control unit 8b indirectly controls the waste developer conveying mechanism 60 and the bottle driving mechanism 63 by controlling the printing unit 4.

The device control unit 8b operates the waste developer conveying mechanism 60 and the bottle driving mechanism 63 by operating the motor 4a of the printing unit 4 when predetermined operating conditions are satisfied.

Specifically, the operating condition is a condition established between the start and the end of the printing process. That is, the operating conditions of the waste developer conveying mechanism 60 and the bottle driving mechanism 63 in the present embodiment are conditions under which the printing unit 4 executes the printing process.

For example, the operating conditions are established from the generation of the print job as the execution request of the printing process to the completion of the printing process corresponding to the print job.

However, the device control unit 8b prohibits the printing unit 4 from performing the printing process when the state determination unit 8a determines a full state to be described later. The full state is a state in which the amount of the waste developer 9x in the bottle 5 has reached a predetermined upper limit.

The state determination unit 8a determines that the full state has occurred when the level of the detection signal Sg1 of the capacitive sensor 7 is out of the predetermined allowable range. When the level of the detection signal Sg1 is within the allowable range, the state determination unit 8a determines the amount of the waste developer 9x in the bottle 5 based on the level of the detection signal Sg1.

Further, the state determination unit 8a notifies the determination result through the display device 802. For example, when determining that the full state has occurred, the state determination unit 8a notifies that the bottle 5 needs to be replaced. The state determination unit 8a causes the display device 802 to display the determination result of the amount of the waste developer 9x in the bottle 5.

### Second Embodiment

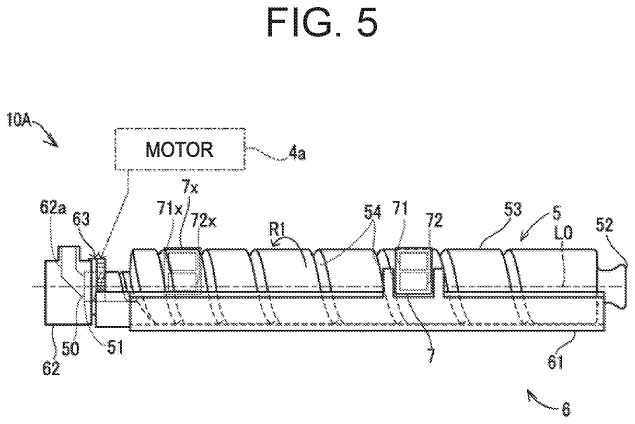

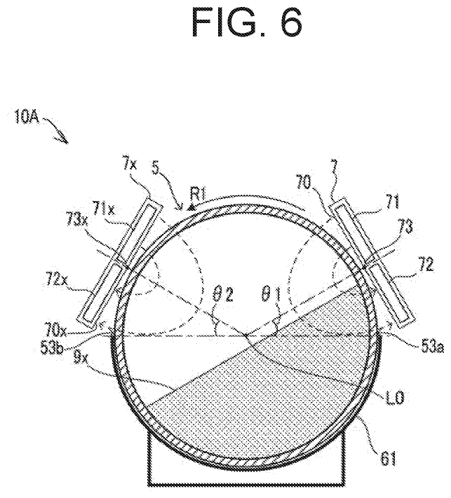

Next, the image forming apparatus 10A according to a second embodiment will be described with reference to FIGS. 5 and 6. The image forming apparatus 10A has a configuration in which another capacitive sensor 7x is added to the image forming apparatus 10.

The capacitive sensor 7x is a parallel capacitive sensor which has a detection electrode 71x and a ground electrode 72x arranged in parallel, just as the capacitive sensor 7. The capacitive sensor 7x has a detection surface 70x of capacitance formed by the detection electrode 71x and the ground electrode 72x arranged in parallel (see FIG. 6).

The capacitive sensor 7x is an example of a second capacitive sensor. The detection electrode 71x and the ground electrode 72x are examples of the second detection electrode and the second ground electrode, respectively.

The capacitive sensor 7x is disposed such that its detection surface 70x directly faces a portion of the second outer peripheral region 53b of the bottle 5 which is positioned obliquely upward with respect to the rotation center line L0 of the bottle 5 (see FIG. 6).

The capacitive sensor 7x is arranged such that the detection electrode 71x and the ground electrode 72x are arranged vertically and the detection surface 70x faces obliquely downward.

For example, it is conceivable that the capacitive sensor 7x is arranged such that the elevation angle θ2 at which an intermediate portion 73x between the detection electrode 71x and the ground electrode 72x on a detection surface 70x is viewed from the rotation center line L0 is 15 to 30 degrees.

In the present embodiment, the capacitive sensor 7 can detect a change in the amount of the waste developer 9x with high sensitivity under a situation where the amount of the waste developer 9x in the bottle 5 is relatively small. On the other hand, the capacitive sensor 7x can detect a change in the amount of the waste developer 9x with high sensitivity under a situation where the amount of the waste developer 9x in the bottle 5 is relatively large.

In the present embodiment, when the detection amount of the capacitive sensor 7 is lower than a predetermined reference electrostatic capacitance, the state determination unit 8a determines the amount of the waste developer 9x in the bottle 5 based on the detection amount of the capacitive sensor 7. When the amount detected by the capacitive sensor 7 exceeds the reference electrostatic capacitance, the state determination unit 8a determines the amount of the waste developer 9x in the bottle 5 based on the amount detected by the capacitive sensor 7x.

Specifically, a first relational data and a second relational data are stored in the secondary storage device 83 in advance. The first relational data is data representing a correspondence relationship between a detection amount of the capacitive sensor 7 in a predetermined range from the predetermined first minimum electrostatic capacitance to the predetermined first maximum electrostatic capacitance and an amount of the waste developer 9x in a predetermined range from the predetermined minimum waste developer amount to the predetermined intermediate waste developer amount. The first maximum electrostatic capacitance corresponds to the reference electrostatic capacitance.

The second relational data is data representing a correspondence relationship between the detection amount of the capacitive sensor 7x in the range from the predetermined second minimum electrostatic capacitance to the predetermined second maximum electrostatic capacitance and the amount of the waste developer 9x in the range from the intermediate waste developer amount to the predetermined maximum waste developer amount.

When the amount detected by the capacitive sensor 7 is less than the reference electrostatic capacitance, the state determination unit 8a converts the amount detected by the capacitive sensor 7 into the amount of the waste developer 9x based on the first relational data. When the amount detected by the capacitive sensor 7 exceeds the reference electrostatic capacitance, the state determination unit 8a converts the amount detected by the capacitive sensor 7x into the amount of the waste developer 9x based on the second relational data.

By adopting the image forming apparatus 10A, the state determination unit 8a can detect a change in the amount of the waste developer 9x with high sensitivity in a wide range of situations ranging from a situation where the amount of the waste developer 9x in the bottle 5 is small to a situation where the amount of the waste developer 9x in the bottle 5 is large.

In the present embodiment, the capacitive sensor 7x is disposed on the first end 51 side of the bottle 5, with respect to the capacitive sensor 7 (see FIG. 5).

The bottle 5 rotates to transport the waste developer 9x towards the second end 52. Therefore, the portion of the bottle 5 closer to the first end 51 becomes full later than the portion closer to the second end 52. Therefore, since the capacitive sensor 7x is disposed near the first end 51 of the bottle 5, the state determination unit 8a can detect a change in the amount of the waste developer 9x with high sensitivity until the bottle 5 becomes full.

### Third Embodiment

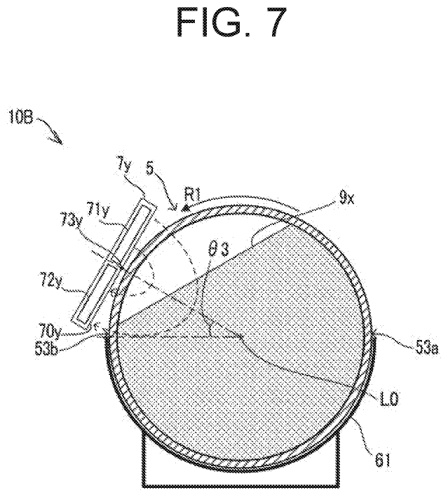

Next, an image forming apparatus 10B according to a third embodiment will be described with reference to FIG. 7. The image forming apparatus 10B has a configuration in which the capacitive sensor 7 of the image forming apparatus 10 is replaced with a capacitive sensor 7y.

The capacitive sensor 7y is the parallel capacitive sensor having a detection electrode 71y and a ground electrode 72y arranged in parallel, just as the capacitive sensor 7. The capacitive sensor 7y has an capacitance detection surface 70y formed by the detection electrode 71y and the ground electrode 72y arranged in parallel (see FIG. 7).

The capacitive sensor 7y is arranged such that the detection electrode 71y and the ground electrode 72y are arranged vertically and the detection surface 70y is oriented horizontally or obliquely downward.

The capacitive sensor 7y is disposed such that its detection surface 70y directly faces a portion of the second outer peripheral region 53b of the outer peripheral surface 53 of the bottle 5 which is positioned at the same height as or obliquely above the rotation center line L0 of the bottle 5.

In the example shown in FIG. 7, the capacitive sensor 7y is arranged in such a state that the detection surface 70y thereof directly faces a portion of the second outer peripheral region 53b which is positioned obliquely upward with respect to the rotation center line L0 of the bottle 5.

For example, it is conceivable that the capacitive sensor 7y is arranged such that the elevation angle θ2 of viewing the intermediate portion 73y between the detection electrode 71y and the ground electrode 72y on the detection surface 70y from the rotation center line L0 is 15 to 30 degrees.

With the use of the image forming apparatus 10B, the state determination unit 8a can detect a change in the amount of the waste developer 9x with high sensitivity under a situation where the amount of the waste developer 9x in the bottle 5 is relatively large.

It should be noted that the description of the one aspect of the image forming apparatus according to the present disclosure, and the technical scope of the present disclosure is not limited to the above embodiment. The present disclosure may be variously changed, replaced, and modified without departing from the spirit of the technical idea, and the claims include all embodiments that can be included in the scope of the technical idea.

What is claimed is:

1. An image forming apparatus comprising:
a printing unit for performing a printing process for forming a toner image on a sheet and discharging a powdered waste developer;
a bottle which is a container having an opening formed at a first end in a longitudinal direction, is disposed in a state in which the longitudinal direction is sideways, and is rotationally driven in a predetermined rotation direction, whereby the waste developer conveyed from the printing unit to the opening is accommodated inside and the waste developer inside is conveyed to a second end side in the longitudinal direction; and
a first capacitive sensor having a first detection electrode and a first ground electrode arranged in parallel, where a first detection surface of an electrostatic capacitance formed by the first detection electrode and the first ground electrode is arranged to directly face a portion of an outer peripheral surface of the bottle which is positioned obliquely upward with respect to a center line of rotation of the bottle in a region which moves from a bottom to a top when the bottle rotates in the predetermined rotation direction.

2. The image forming apparatus according to claim 1, further comprising a second capacitive sensor having a second detection electrode and a second ground electrode arranged in parallel, where a second detection surface of an electrostatic capacitance formed by the second detection electrode and the second ground electrode is arranged to directly face a portion of the outer peripheral surface of the bottle which is positioned obliquely upward with respect to the center line of rotation of the bottle in a region which moves from the top to the bottom when the bottle rotates in the predetermined rotation direction.

3. The image forming apparatus according to claim 2, wherein
the second capacitive sensor is disposed on the first end side of the bottle, with respect to the first capacitive sensor.

4. The image forming apparatus according to claim 2, further comprising
a state determination unit which determines an amount of the waste developer in the bottle based on a detection amount of the first capacitive sensor when a detection amount of the first capacitive sensor is lower than a predetermined reference electrostatic capacitance, and determines the amount of the waste developer in the bottle based on a detection amount of the second capacitive sensor when the detection amount of the first capacitive sensor is higher than the reference electrostatic capacitance.

5. An image forming apparatus comprising:
a printing unit for performing a printing process for forming a toner image on a sheet and discharging a powdered waste developer;
a bottle which is a container having an opening formed at a first end in a longitudinal direction, is disposed in a state in which the longitudinal direction is sideways, and is rotationally driven in a predetermined rotation direction, whereby the waste developer conveyed from the printing unit to the opening is accommodated inside and the waste developer inside is conveyed to a second end side in the longitudinal direction; and
a capacitive sensor having a first detection electrode and a first ground electrode arranged in parallel, where a detection surface of an electrostatic capacitance formed by the first detection electrode and the first ground electrode is arranged to directly face a portion of an outer peripheral surface of the bottle which is positioned at the same height as or obliquely upward with respect to a center line of rotation of the bottle in a region which moves from a top to a bottom when the bottle rotates in the predetermined rotation direction.
